(19) United States
(12) Patent Application Publication
(10) Pub. No.: US 2003/0196525 A1
(43) Pub. Date: Oct. 23, 2003

(54) Quick-release wrench for driving two different bolts

(76) Inventor: Hsiu-Ching Huang, Taipei (TW)

Correspondence Address: Alan D. Kamrath, Rider, Bennett, Egan & Arundel, LLP, Suite 2000, 333 South Seventh Street, Minneapolis, MN, 55402, US

(21) Appl. No.: 10/126,998

(22) Filed: Apr. 19, 2002

(51) Int. Cl. B25B 13/12

(52) U.S. Cl. 81/179

(57) ABSTRACT

A quick-release wrench capable of driving two different bolts includes a head and a handle extending from the head. The head includes first and second jaws. The first jaw includes a plate for contact with a head of a bolt and defines a space. The plate defines a hole in communication with the space. An engagement device includes first and second teeth projecting from a slide and a spring. The first tooth is shorter than the second tooth. The first tooth includes a top and a slope extending from the top. Similarly, the second tooth includes a top and a slope. The top of the first tooth is smaller than the top of the second tooth. The engagement device is received in the space so that the first and second teeth extend through the hole and that the slide is biased by the spring.

### BACKGROUND OF INVENTION

1. Field of Invention

The present invention is related to a wrench and more particularly to a quick-release wrench for driving two bolts of different sizes.

2. Related Prior Art

A person can use a wrench to drive a bolt or the like. When using the wrench in a limited space, the user is only allowed to pivot the wrench in a direction such as clockwise by a limited angle. Before being able to further rotate the bolt, the user has to disengage the wrench from the bolt and pivot the wrench 50 in an opposite direction such as counterclockwise by a limited angle. Then, the user has to engage the wrench with the bolt again so that he or she can pivot the wrench so as to rotate the bolt clockwise by a limited angle. This operation is inconvenient and therefore takes a lot of time.

The present invention is therefore intended to obviate or at least alleviate the problems encountered in prior art.

### SUMMARY OF INVENTION

It is the primary objective of the present invention to provide a quick-release wrench capable of driving two bolts of different sizes.

According to the present invention, a quick-release wrench capable of driving two different bolts includes a head and a handle extending from the head. The head includes first and second jaws. The first jaw includes a plate for contact with a head of a bolt and defines a space. The plate defines a hole in communication with the space. An engagement device includes first and second teeth projecting from a slide and a spring. The first tooth is shorter than the second tooth. The first tooth includes a top and a slope extending from the top. Similarly, the second tooth includes a top and a slope. The top of the first tooth is smaller than the top of the second tooth. The engagement device is received in the space so that the first and second teeth extend through the hole and that the slide is biased by the spring.

The wrench may include two engagement devices. Each of the jaws includes a plate defining a hole and defines a space for receiving one of the engagement devices.

A cover is received in a shallow cavity defined in the head of the wrench in order to retain the engagement devices in the spaces.

Other objects, advantages, and novel features of the invention will become more apparent from the following detailed description when taken in conjunction with the attached drawings.

### BRIEF DESCRIPTION OF DRAWINGS

The present invention is described through detailed illustration of embodiments referring to the attached drawings wherein:

FIG. 1 is a perspective view of a wrench capable of driving two bolts of different sizes according to an embodiment of the present invention;

FIG. 2 is an exploded view of the wrench shown in FIG. 1;

FIG. 3 shows the wrench shown in FIG. 1 driving a head of a bolt clockwise;

FIG. 4 is similar to FIG. 3 but showing the wrench driving the head counterclockwise;

FIG. 5 is similar to FIG. 3 except for showing the wrench driving a head of a bolt of a smaller size; and

FIG. 6 is a perspective view of a wrench capable of driving two bolts of different sizes according to another embodiment of the present invention.

### DETAILED DESCRIPTION OF EMBODIMENTS

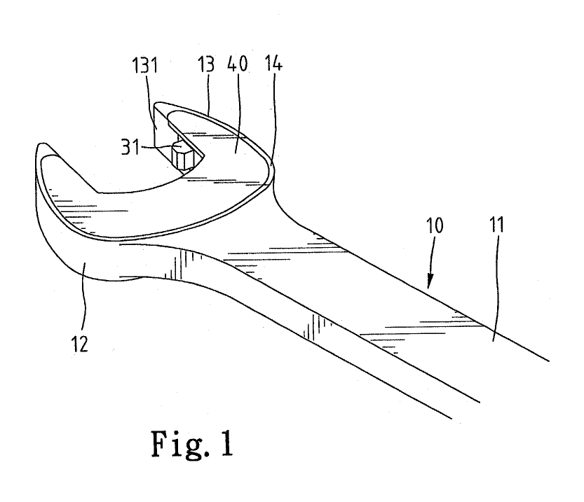

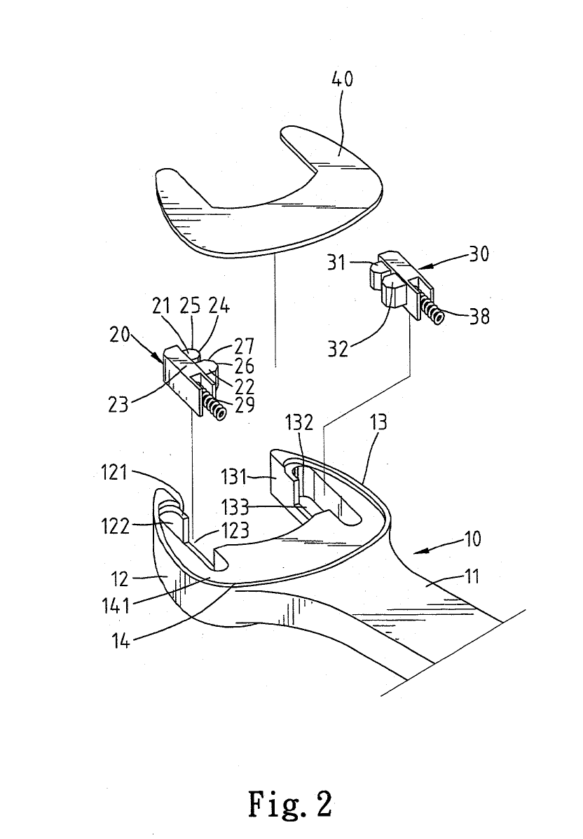

Referring to FIGS. 1 and 2, a wrench 10 capable of driving two bolts of different sizes according to the present invention includes a head 14 and a handle 11 extending from the head 14.

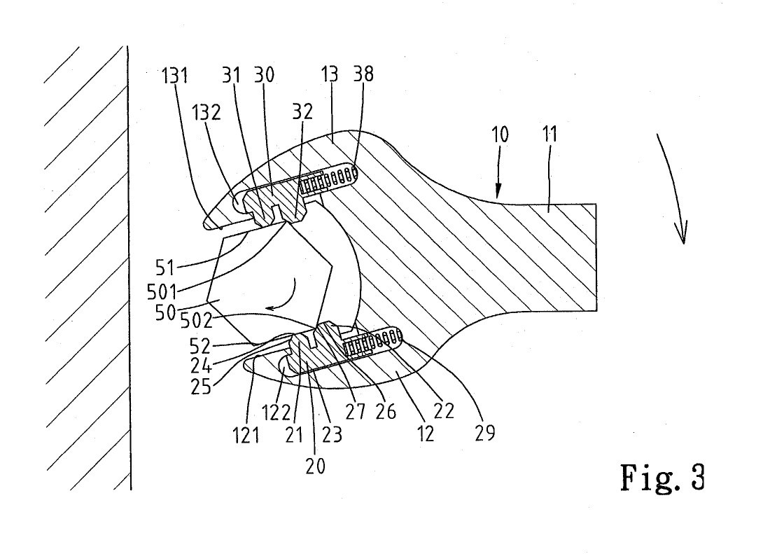

Two jaws 12 and 13 extend from the head 14. The jaw 12 includes a plate 121 for contact with a head of a bolt 50 (see FIG. 3) and defines a space 122. The plate 121 defines a hole 123 in communication with the space 122. Similarly, the jaw 13 includes a plate 131 and defines a space 132 and the plate 131 defines a hole 133.

The wrench 10 includes two engagement devices 20 and 30. The engagement device 20 includes teeth 21 and 22 projecting from a slide 23. The tooth 21 is shorter than the tooth 22. The tooth 21 includes a top 24 and a slope 25 extending from the top 24. Similarly, the tooth 22 includes a top 26 and a slope 27. The top 24 is smaller than the top 26. Similarly, the engagement 30 includes teeth 31 and 32 and a slide 33, and the tooth 31 includes a top 34 and a slope 35, and the tooth 32 includes a top 36 and a slope 37.

The engagement device 20 is received in the space 122 so that the teeth 21 and 22 extend through the hole 123. A spring 28 is also received in the space 122 in order to bias the slide 23. An end of the spring 28 is received in a recess (not numbered) defined in an end of the slide 23. Similarly, the engagement device 30 and a spring 39 are received in the space 132.

The head 14 of the wrench 10 defines a shallow cavity 141 so as to receive a cover 40 in order to retain the engagement devices 20 and 30 in the spaces 122 and 132.

Referring to FIG. 3, the head of the bolt 50 is engaged with the wrench 10. The head of the bolt 50 includes a surface 51, a surface 52 extending parallel to the surface 51, a corner 501 formed next to the surface 51 and a corner 502 formed next to the surface 52. The top 24 of the tooth 21 and the top 34 of the tooth 31 respectively contact the surfaces 51 and 52. The slope 27 of the tooth 22 and the slope 37 of the tooth 32 respectively contact the corners 501 and 502. Thus, a user can pivot the wrench 10 so as to rotate the bolt 50.

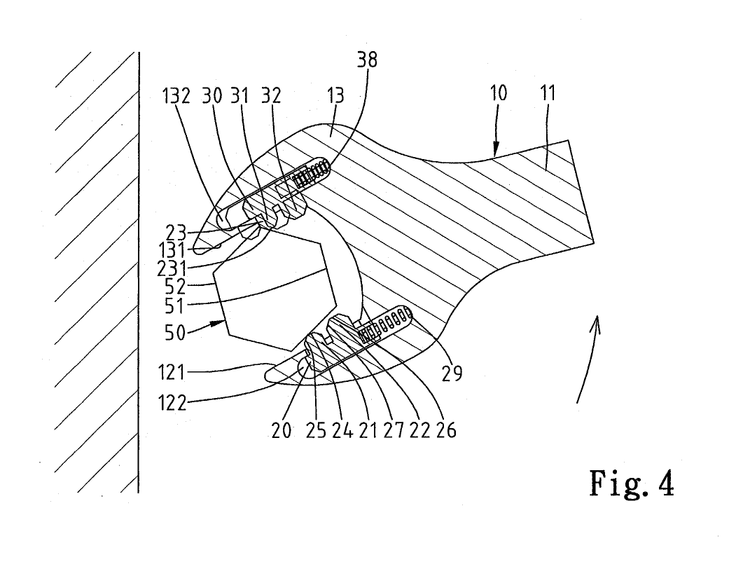

When using the wrench 10 in a limited space, the user is only allowed to pivot it in a direction such as clockwise by a limited angle. Before being able to further rotate the bolt 50, instead of disengaging the head of the wrench from the head of the bolt 50 as required in prior art, a user only has to pull the head 14 of the wrench 10 from the head of the bolt 50 by a limited distance until the slope 27 of the tooth 22 and the slope 37 of the tooth 32 leave the corners 501 and 502, respectively. The top 24 of the tooth 21 are small so that the top 24 and slope 25 of the tooth 21 perform like a continuous curved surface. Similarly, the top 34 and slope 35 of the tooth 31 perform like a continuous curved surface. Thus, counterclockwise pivot of the wrench 10 causes the surface 51 to push the teeth 31 and 32 formed on the slide 33 toward the spring 38. Clockwise pivot of the wrench 10 causes the surface 52 to push the teeth 21 and 22 formed on the slide 23 toward the spring 28. Therefore, the user can pivot the wrench 10 in an opposite direction such as counterclockwise by a limited angle without rotating bolt 50 as shown in FIG. 4. The user can again engage the head 14 of the wrench 10 with the head of the bolt 50 as shown in FIG. 3 in order to further rotate the bolt clockwise by a limited angle.

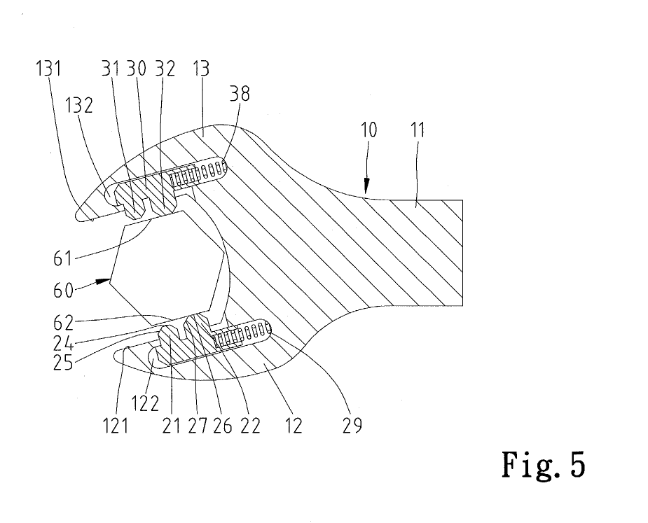

FIG. 5 shows the head 14 of the wrench 10 engaged with a head of a bolt 60 of a size smaller than that of the bolt 50. The head of the bolt 60 includes a surface 61 and a surface 62 opposite to the surface 61. The top 26 of the tooth 22 and the top 36 of the tooth 32 are engaged with the surfaces 61 and 62, respectively. Thus, the user can pivot the wrench 10 so as to rotate the bolt 60. After pivoting the wrench 10 so as to drive the bolt 60 in a direction by an angle, the user can pull the wrench 10 from the bolt 60 by a limited distance so that the top 26 of the tooth 22 and the top 36 of the tooth 32 are disengaged from the surfaces 61 and 62, respectively. Thus, the user can pivot the wrench 10 in an opposite direction without driving the bolt 60.

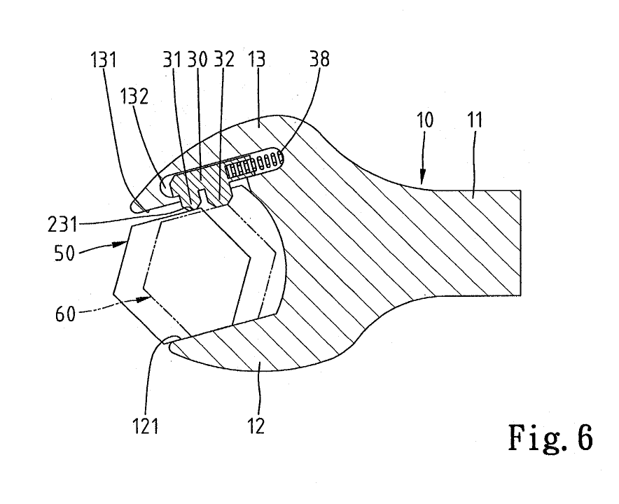

FIG. 6 shows a wrench 10′ according to a second embodiment of the present invention. The wrench 10′ includes only one engagement device 20 instead of two engagement devices 20 and 30. The wrench 10′ is otherwise identical to the wrench 10 and therefore will not be further described in detail.

The present invention has been described through detailed illustration of the preferred embodiment thereof. Those skilled in the art can derive many variations from the preferred embodiment without departing from the scope of the present invention. Therefore, the preferred embodiment shall not limit the scope of the present invention. The scope of the present invention can only be defined in the attached claims.

1. A quick-release wrench capable of driving two different bolts including:
a handle 11;
a head (14) from which the handle (11) extends, the head (14) including two jaws (12, 13), at least one of the jaws including a plate (121) for contact with a head of a bolt and defining a space (122), the plate (121) defining a hole (123) in communication with the space (122); and
at least one engagement device (20) including an elastic element (28), a slide (23) and first and second teeth (21, 22) projecting from the slide (23) and each including a top (24; 26) and a slope (25; 27) extending from the top (24; 26), wherein the first tooth (21) is shorter than the second tooth (22), wherein the at least one engagement device (20) is received in the space (122) so that the first and second teeth (21; 22) extend through the hole (123) and that the slide (23) is biased by the elastic element (28).

2. A wrench according to claim 1 including two engagement devices (20; 30), wherein each of the jaws (12, 13) defines a space (122; 132) for receiving one of the engagement devices (20, 30).

3. A wrench according to claim 2 including a cover (40) attached to the head (14) of the wrench to retain the engagement devices (20, 30) in the spaces (122, 132).

4. A wrench according to claim 3 wherein the head (14) of the wrench (10) defines a shallow cavity (141) in order to receive the cover (40).

5. A wrench according to claim 1 wherein the elastic element (28) is a spring.
